(19) United States
(12) Patent Application Publication
(10) Pub. No.: US 2008/0271775 A1
(43) Pub. Date: Nov. 6, 2008

(54) Solar power

(76) Inventor: Jack Denver Bailey, Beckley, WV (US)

Correspondence Address: Jack D. Bailey Jr., Apt. 92, 510 Ewart Avenue, Beckley, WV, 25801, US

(21) Appl. No.: 11/716,707

(22) Filed: May 1, 2007

(51) Int. Cl. H02N 6/00

(52) U.S. Cl. 136/245

(57) ABSTRACT

A unique solar powered invention(s) to be used for the charging of mobile communications devices/cellular telephone batteries for extend usage. The distinctive invention(s) consist of solar panel(s) to collect natural light for generating a power source, a battery for storing solar energy, and the option to use the current most used power source A/C to transfer energy to the cellular telephone battery by having the appropriate cellular telephone adapters to connect the invention(s) to the cellular telephone to be able to recharge the cellular telephone battery for extensive usage. The invention(s) has a detachable A/C adapter, a switch in order to choose what source of power would be appropriate and lights controlled by a button to indicate if the solar battery is empty or full in the invention(s).

### TECHNICAL FIELD OF THE INVENTION(S)

The present invention(s) relates to the general art of cellular telephones, and the particular field of cellular telephone accessories. The invention(s) will be a source of recharging power for cellular telephones in areas were a power source is not accessible.

### BACKGROUND OF THE INVENTION

In Present times technology has been provided to obtain a longer lasting cellular telephone battery but that still is not enough for consumers today with the excessive usage and limited power sources the longer lasting battery is almost a moot point. A power source is still needed to recharge the cellular telephone battery and these sources are not always reachable. A power source with multiple options is in vital need for today's consumers using cellular telephones. Solar power provides these needs of multiple power sources by using natural light from the sun or by the old fashion A/C outlets.

### SUMMARY OF THE INVENTION

The present invention(s) is to provide accessible power sources by providing the technology of a solar power and A/C power cellular telephone charger. The power source(s) are designed to be used separately by providing the consumer with a switch to choose which source of power would be accessible and appropriate during the time of need.

Another object of the invention(s) is to provide longer usage of the cellular telephone itself by having a power source available by using the sunlight as a source of power.

Still another object of the invention(s) is to provide longer usage of the cellular telephone itself by having a secondary source of power if needed and available by using the current and main source of power A/C outlet(s).

Yet another object of the invention(s) is to provide longer usage of the cellular telephone itself by having a third source of power a solar battery for storing power for a quick instant boost to recharge the cellular telephone battery.

Still another object is to provide a small sleek device for easy carriage of a power source for all cellular telephone batteries. This will provides an accessible source of power to promote longer usage of cellular telephone usage.

Another object is to provide a source of power for all cellular telephone batteries by having multiple adapters. Promote(s) longer cellular telephone usage by providing an accessible power source.

Still another object is to provide an economical cost to the consumer for the invention(s) as well as providing a small economical solution for a power source.

Another object is the invention(s) is extremely simplistic to make with a low manufacturing cost and is exceptionally user (consumer) friendly for those that may feel technological frightened.

Yet another object is the invention(s) is to provide the consumer with indicators to eliminate the guessing of if the solar battery in the invention(s) is full or empty by pressing a small button to activate indicators.

Still another object of the invention(s) is to provide the consumer the ability to detach the A/C power adapter helping make the invention(s) more sleek and compact for carriage.

The present invention(s) will be disclosed with the following drawings and description(s) is not to limit the possibility or fortitude of the invention(s). They are purely described as favored embodiments of the current invention(s).

### BRIEF DESCRIPTION OF THE DRAWINGS

The invention(s) will give better knowledge and objects other than those described above will become perceptible when consideration is given to the following detailed description thereof. Such description makes reference to the drawings wherein:

FIG. 1 is an angle view(s) of a solar powered and optional A/C powered charging device according to the current invention(s).

FIG. 2 is an angle view(s) of a solar powered device according to the current invention(s).

FIG. 3 is a rear view of the optional solar powered charging device according to the present invention(s).

FIG. 4 is a perspective view of an optional solar powered charging device in accordance to the current invention(s).

FIG. 5 is a rear view of solar powered charging device in accordance with the present invention(s).

FIG. 6 is a rear view of the details of the solar powered charging device according to the current invention(s).

### REFERENCE NUMBERS FOR THE PRESENT INVENTION(S)

(8) Solar Powered and Optional A/C Powered Cellular Telephone Charger
(9) Pocket Size Solar Powered Cellular Telephone Charger
(10) Cellular Telephone Adapter(s)
(11) A/C Adapter(s)
(12) A/C Adapter Plug-in
(13) Solar Panel
(14) Button to Display L.E.D.'s
(15) L.E.D's to Display Full or Empty Solar Battery in Solar Powered Charging Device.
(16) Switch for Choosing A/C Power or Solar Power.
(17) Rear Lid
(18) Screw(s)
(19) Indention to Remove Lid to Access Solar Battery
(20) Battery Lid (to Access Solar Battery)
(21) Battery Housing
(22) Solar Battery

### DETAILED DESCRIPTION OF THE PREFERRED EMBODIMENT

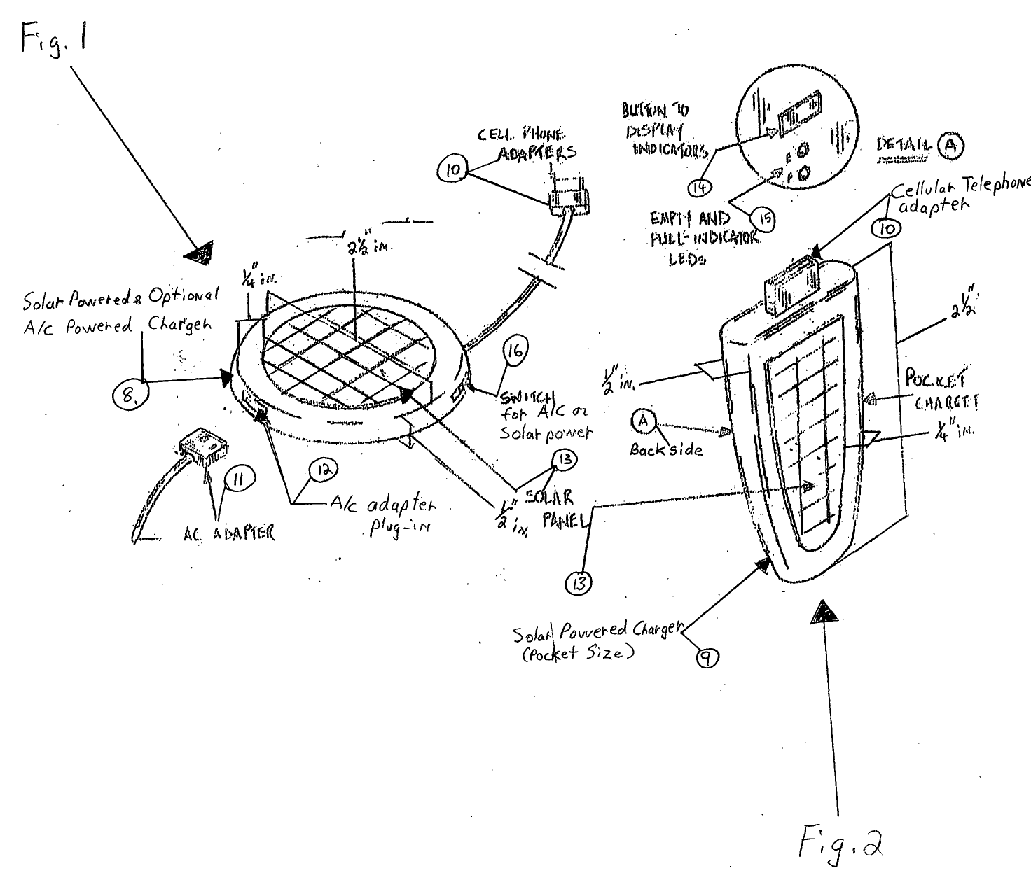

With reference to FIG. 1, the solar powered and optional A/C powered cellular telephone charger [8] is sleek, lightweight, and small for easy carriage. The charger [8] is styled accordingly too today's fashion, can be manufactured easily, and can be presented in any color of the consumers choosing. The solar powered [13] will gather an energy source from natural light and convert the power into the cellular telephone battery for continued usage of the cellular telephone. The A/C adapter [11] will provide a secondary source of power if accessible to the consumer. The A/C adapter [11] is detachable and attachable by using the A/C adapter plug-in [12] on the side of the charger [8] helping make the charger [8] compact for carriage. The switch [16] located on the side of the charger [8] lets the consumer choose the use of solar power or A/C power for a source to charge the cellular telephone to extend usage. The cellular telephone adapter [10] is used to connect the charger [8] to the cellular telephone to transfer energy into the cellular telephone battery creating the ability for extended cellular telephone usage.

With reference to FIG. 2, the pocket size solar powered cellular telephone charger [9] is used to provide the consumer with a power source to regenerate power to the cellular telephone battery for extended usage of the cellular telephone. The pocket charger [9] is compact, lightweight, and fashioned with today's consumer needs. The pocket charger [9] is easily manufactured and has low cost of being made this will help potential profitability. The charger [9] has a solar panel [13] to generate a power source to transfer the energy to the cellular telephone battery for extensive usage of the cellular telephone. The cellular telephone adapter [10] will provide the means to connect the cellular telephone to the charger [9] in order to transfer a source of power into the cellular telephone battery for longer usage of the cellular telephone. The charger [9] has a push button [14] to display L.E.D indicators [15] if full or empty.

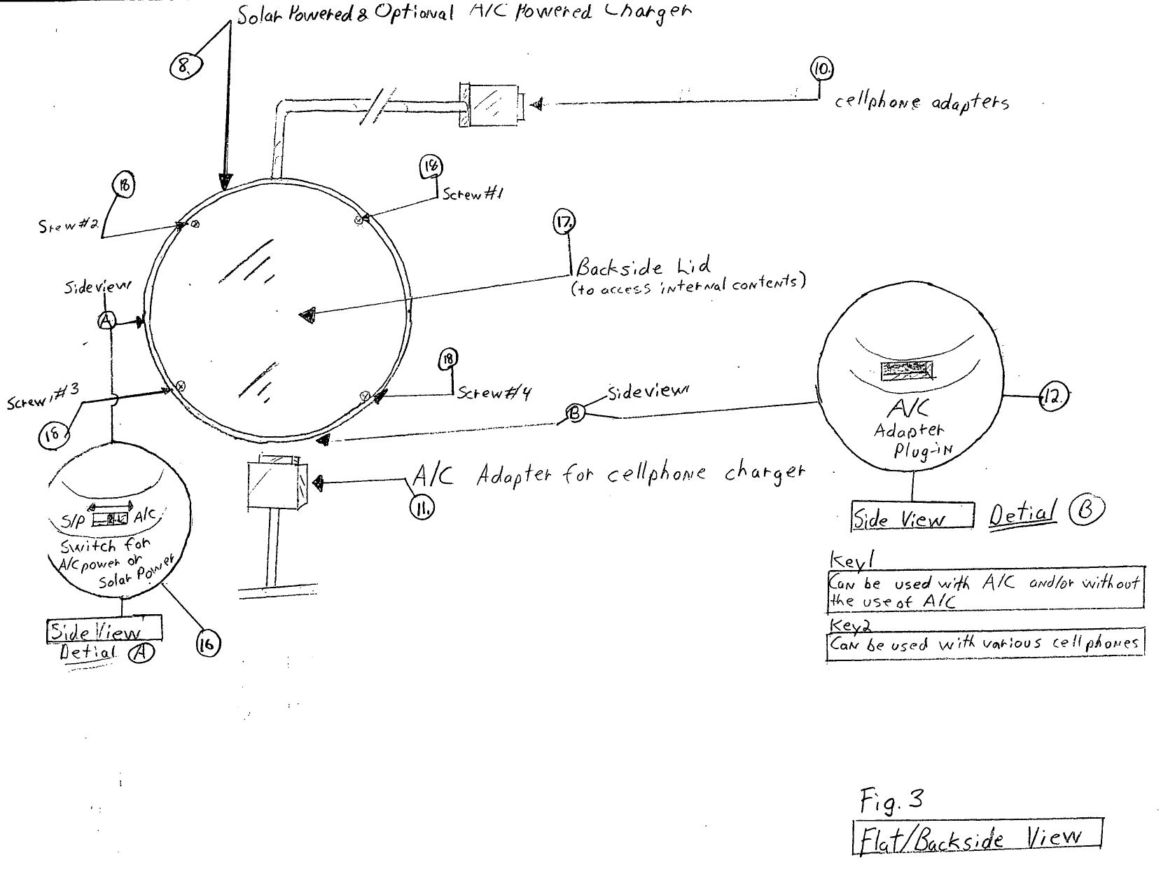

With reference to FIG. 3, the solar powered and optional A/C powered cellular telephone charger [8] is lightweight and has an easily accessible rear lid [17] to access internal parts of the charger [8] for repairing if needed. To access internal parts of the charger [8] the person initiating the repair must remove four screws [18] in order to repair the charger [8] if needed. The switch [16] for choosing A/C or solar power source is easily accessible and gives the consumer a choice to fit the consumer's needs. The cellular telephone adapter [10] is needed to transfer a source of power from the charger [8] to the cellular telephone battery for longer usage of the cellular telephone. The A/C adapter [11] is a secondary power source if the necessary outlets are available to receive energy and transfer that energy to the charger [8] to the cellular telephone battery for lengthy usage of the cellular telephone. The A/C adapter plug-in [12] will allow the disconnection of the A/C adapter [11] for the purpose of having a much more compact charger [8] for better carriage.

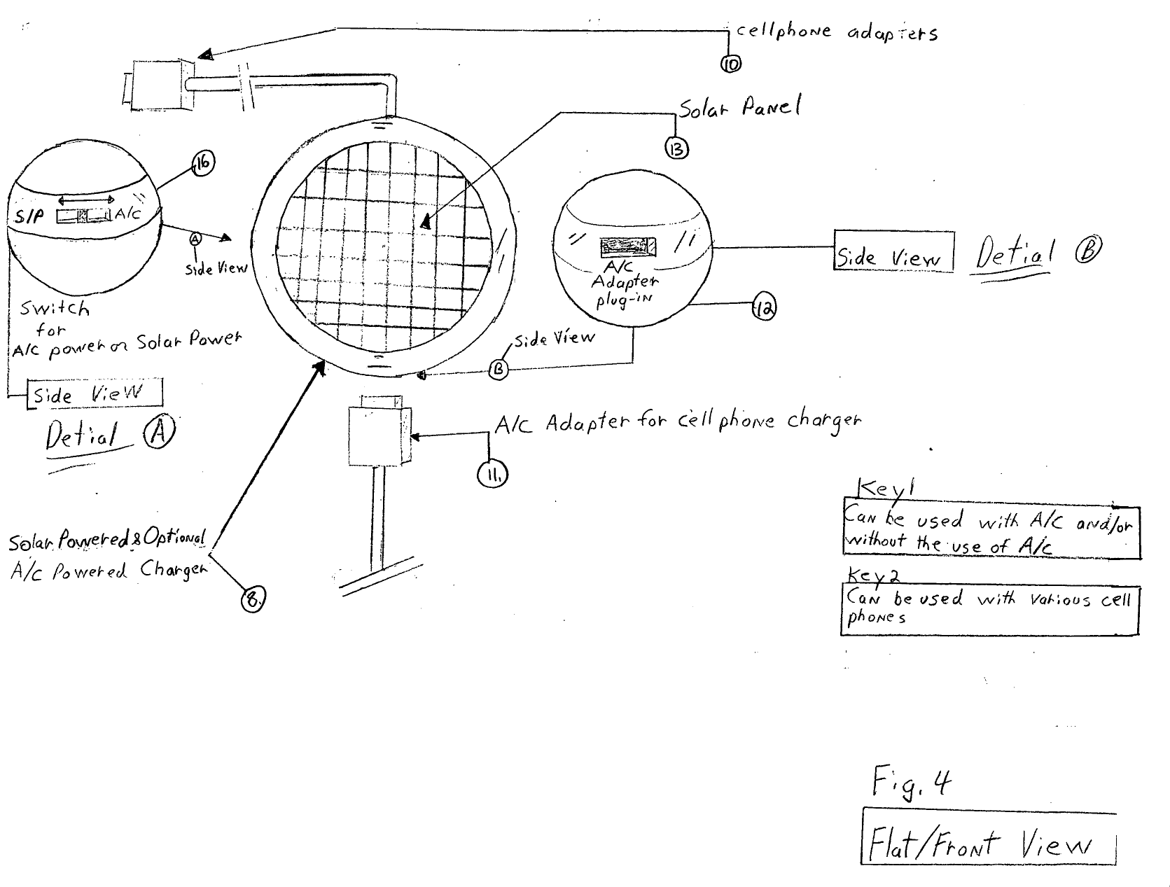

With reference to FIG. 4, the solar powered and optional A/C powered cellular telephone charger [8] is diversified by having the feature of A/C power capabilities added-on. The A/C adapter [11] makes the solar charger [8] more compact be having the ability to disconnect from the charger [8] entirely. The A/C adapter [11] connects and disconnects from the A/C adapter plug-in [12] located on the side of the solar charger [8] creating a travel type charger. The solar panel [13] collects natural light to convert it into useable energy to be transferred into the cellular telephone battery to create extended use of the cellular telephone. The switch [16] located on the side of the solar charger [8] is used to choose the option of using an A/C power source or a solar powered source of energy to charge the mobile communication device. The cellular telephone adapter [10] connects from the solar charger [8] to the cellular telephone battery to transfer energy into the battery for longer usage of the mobile communication device.

With reference to FIG. 5, the pocket solar powered charger [9] is compact for easy carriage for a traveler. The cellular telephone adapter [10] is used to connect to the cellular telephone battery to increase the capability of the mobile communication device by transferring a power source to the cellular battery. The push button [14] is used to display the L.E.D's [15] if empty or full. The indention [19] on the back of the solar charger [9] is used to help make the removal of the battery lid [20] to access an internal accessory. The screws [18] are on the rear of the charger [9] to make the internal parts accessible by removing the rear lid [17] to make any necessary repairs.

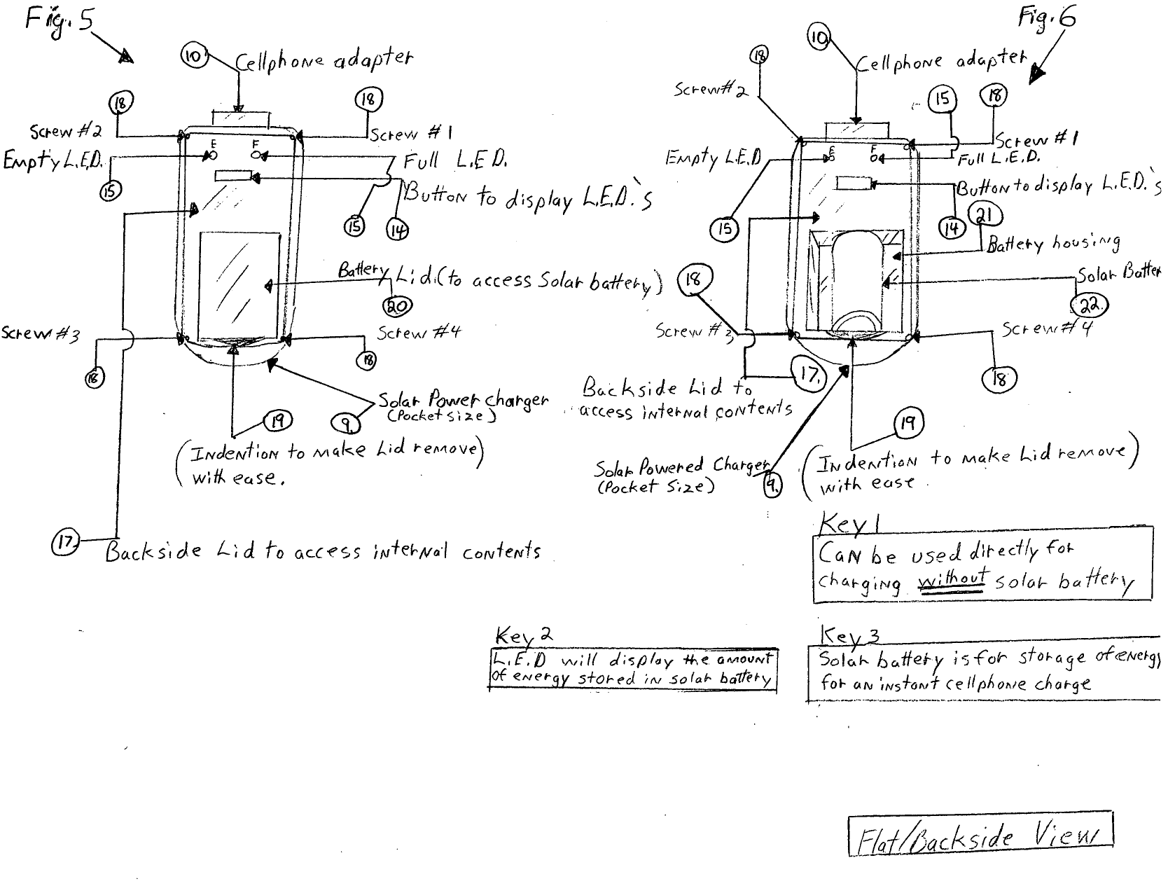

With reference to FIG. 6, the pocket size solar powered charger [9] is unique because of the ability to not only charger the cellular telephone battery from the natural light of the sun but because it has a secondary attribute a solar battery [22] to store a power source for an instant boost to the cellular telephone battery. The solar battery [22] in the solar charger [9] is not need to charge the cellular telephone the battery [22] is a luxury for an instant charger. The solar battery [22] is stored in the battery housing [21] of the pocket size solar charger [9]. The screws [18] are used for the purpose of removing the rear lid [17] for access to the internal parts. The full and empty L.E.D's [15] display the energy level of the solar battery [22] contained in the solar charger [9] this will help make when deciding on an instant boost or a regular charge to the mobile communication device. The push button [14] when pressed displays the full and empty L.E.D's [15] to know the level of the solar battery [22] in the pocket charger [9] to make a choice of energy source. The cellular telephone adapter [10] is used to connect the pocket charger [9] to the cellular telephone battery to transfer an energy source for extended use of the mobile communications device. The indention [19] is not only used to make the lid removal easier but also for removing the solar battery [22] if needed.

Although favored embodiment(s) have been described in the figures of the existing invention(s) it is evident that modifications may be made without departing from the character of the present invention(s). It is not preferred to bind the invention(s) to the precise creation and operations publicized and explained. Accordingly, within the extent of the appended claims the invention(s) may be accomplished other than has been distinctively illustrated herein.

I claim:

1. A pocket size solar powered cellular telephone charger for providing supplementary battery charging capability to a mobile communications device, the telephone scheme compromising:
A pocket sized solar powered charging device for a mobile communications device/cellular telephone to extend usage of.
A solar battery designed to store solar energy for and instant transfer of power to the mobile communications device/cellular telephone for extended usage of.
A unique design of the pocket sized solar powered charging device for a mobile communications device/cellular telephone to extend the usage of.
A unique design that can be used with or without the use of the solar battery for charging a mobile communications device/cellular telephone battery for extended usage of.
A push button on the back of the pocket sized solar powered charger to display the level of the solar powered battery contained in the pocket sized solar powered charger by lighting up the L.E.D's located on the rear of the pocket sized solar powered charger indicating if the solar battery is empty or full.
A unique designed solar panel on the pocket sized solar powered charger for a mobile communications device/cellular telephone; to gather natural light and transfer into a power source to be transferred into a mobile communications device/cellular telephone battery for extended usage of.
A unique L.E.D's system for indicating if the solar battery contained in the pocket sized solar powered charger is empty or full.
A unique cellular telephone adapter contained on the pocket sized solar powered charger to have the ability to connect to a mobile communications device/cellular telephone.
A unique lid on the rear of the pocket sized solar powered charger to gain access to the internal parts of the pocket sized solar powered charger.
A unique second lid on the rear of the pocket sized solar powered charger to gain access to the solar battery contained in the pocket sized solar powered charger for a mobile communications device/cellular telephone.
A unique indention to help make the second lid removal easier to access the solar battery contained in the pocket sized solar powered charger for a mobile communications device/cellular telephone.
A unique design of internal and external parts for the pocket sized solar powered charger for a mobile communications device/cellular telephone.

2. A solar powered and optional A/C powered charger for providing supplementary battery charging capability to a mobile communications device/cellular telephone.
A switch, on the side of the solar power and optional A/C powered charger; to provide a choice of a solar power source or an A/C power source to provide energy; to a mobile communications device/cellular telephone battery for longer usage.
A unique designed solar panel installed on the solar powered and optional A/C powered charger for a mobile communications device/cellular telephone; to gather natural light and transfer into a power source to be transferred into a mobile communications device/cellular telephone battery for extended usage of.
A distinctively designed rear lid; for accessing internal parts of the solar powered and optional A/C powered charger for a mobile communications device/cellular telephone.
A uniquely designed A/C plug-in on the side of the solar powered and optional A/C powered charger for a mobile communications device/cellular telephone; to attach the A/C adapter to the solar powered and optional A/C powered charger for a secondary power source; for transferring energy into the mobile communications device/cellular telephone battery for extended usage of.
A distinctively designed A/C adapter for connecting into the solar powered and optional A/C powered charger for a mobile communications device/cellular telephone; in order to receive a secondary source of power from an A/C outlet.
A unique designed cellular telephone adapter to connect to a mobile communications device/cellular telephone; for transferring an energy source from the solar powered and optional A/C charger into a mobile communications device/cellular telephone battery.
A unique design of internal and external parts for the solar powered and optional A/C powered charger for a mobile communications device/cellular telephone.
A unique design that allows the solar powered and optional A/C powered charger for a mobile communications device/cellular telephone; to be used with A/C solely or with solar power solely for an energy source to be transferred to a mobile communications device/cellular telephone battery for longer usage of.
